(19) United States
(12) Patent Application Publication
(10) Pub. No.: US 2022/0384870 A1
(43) Pub. Date: Dec. 1, 2022

(54) BATTERY MODULE FOR A TRACTION BATTERY OF AN ELECTRIC VEHICLE, TRACTION BATTERY FOR AN ELECTRIC VEHICLE, AND METHOD OF MANUFACTURING A TRACTION BATTERY

(71) Applicant: Lisa Draexlmaier GmbH, Vilsbiburg (DE)

(72) Inventors: Peter Wagner, Karlsfeld (DE); Benjamin Bardosch, Landshut (DE); Michael Flieser, Geisenhausen (DE); Alexander Hahn, Roettenbach (DE); Robert Magunia, Geisenhausen (DE); Thomas Sperl, Landau an der Isar (DE)

(21) Appl. No.: 17/750,451

(22) Filed: May 23, 2022

(30) Foreign Application Priority Data
May 25, 2021 (DE) 10 2021 113 418.8

(51) Int. Cl. H01M 10/625; H01M 10/613; H01M 50/489

(52) U.S. Cl. CPC H01M 10/625; H01M 10/613; H01M 50/489; H01M 2220/20

(57) ABSTRACT

A battery module for a traction battery of an electric vehicle is disclosed. The battery module includes at least one heat baffle arranged between two cells of the battery module. A central region of the heat conducting plate is arranged extending in a space between the cells and along a main extension plane of the heat conducting plate. An end region of the heat conducting plate is arranged outside the space and is oriented transversely to the main extension plane and forms a deformable heat transfer surface of the battery module. The end portion is oriented at an acute angle to a reference plane of the heat transfer surface perpendicular to the main extension plane.

### CROSS REFERENCE TO RELATED APPLICATIONS

This application claims priority to German Patent Application 102021113418.8, filed on May 25, 2021, the content of which is herein incorporated by reference

### BACKGROUND OF THE INVENTION

### Field of the Invention

The present invention relates to a battery module for a traction battery of an electric vehicle, a traction battery for an electric vehicle, and a method of manufacturing such a traction battery.

### DESCRIPTION OF THE INVENTION

The present invention is described below mainly in connection with traction batteries for electric vehicles. However, the invention can be used in any accumulator in which large amounts of heat are to be added or removed.

A traction battery of an electric vehicle is configured to store electrical energy for driving the electric vehicle with automotive high voltage, to be discharged during operation for acceleration processes with high amperages and to be charged for electrical braking processes with high amperages. The high currents create thermal losses that must be dissipated as heat to maintain a temperature of the traction battery within a designated operating range. For this purpose, the traction battery can have a temperature control device. For example, a fluid may be used in the temperature control device to remove the heat. The temperature control device can also supply heat to the traction battery when the temperature is below the operating range.

The temperature control unit can be designed as a cooling plate, for example. Heat transfer surfaces of traction battery modules can be thermally coupled to the temperature control unit using gap filler, a paste-like heat transfer material. The gap filler is metered between the heat transfer surfaces and the temperature control device. The battery modules are pressed into the gap filler. The gap filler is distributed between the heat transfer surfaces and the temperature control unit. Voids or gaps of surfaces of the temperature control unit and the heat transfer surfaces are filled. An actual contact area between the temperature control unit and the battery modules is maximized. The gap filler cross-links after impression but can retain elastic properties even in the cured state.

### SUMMARY OF THE INVENTION

One task of the invention is therefore to provide an improved battery module for a traction battery of an electric vehicle, an improved traction battery for an electric vehicle and an improved method for manufacturing such a traction battery using means that are as simple as possible in terms of design. An improvement in this context can relate, for example, to an enlarged contact area for transferring waste heat from the battery module and to simplified tolerance compensation.

A heat transfer surface of a battery module can only achieve a small actual contact area to a temperature control device of a traction battery without an additional tolerance-compensating heat transfer material. Component tolerances, unevenness and surface structures make large-area metallic contact difficult. The small contact area can result in high heat transfer resistance.

In the approach presented here, a heat transfer surface that can be deformed under relatively low force is introduced, which consists of plastically and/or elastically deformable end regions of heat conducting sheets of the battery module. The end regions have a structurally provided spring travel or deformation path. The spring travel or deformation travel is achieved by inclining the end regions relative to a reference plane of the heat transfer surface. The reference plane runs essentially parallel to a surface of the temperature control unit facing the battery module. The end regions, which are inclined before assembly, are pressed against the temperature control device during assembly by a contact force, for example by a mass of the battery module, and thus nestle against the temperature control device, resulting in improved direct metallic contact between the end regions of the heat transfer plates and the temperature control device. The deformable end regions at least partially compensate for component tolerances or unevenness. By snugging the end regions, a layer thickness of additional heat-conducting material introduced between the heat transfer surface and the temperature control device can be minimized, thus further reducing the heat transfer resistance.

A battery module for a traction battery of an electric vehicle is proposed, wherein the battery module comprises at least one heat baffle arranged between two cells of the battery module, wherein a central region of the heat conducting plate extends in a space between the cells along a main extension plane of the heat conducting plate and an end region of the heat conducting plate arranged outside the space between the cells is aligned transversely to the main extension plane and forms a deformable heat transfer surface of the battery module, the end region being aligned at an acute angle to a reference plane of the heat transfer surface extending perpendicularly to the main extension plane.

Furthermore, a traction battery for an electric vehicle is proposed, the traction battery having a temperature control device and at least one battery module in accordance with the approach presented here, the heat transfer surface being pressed against the temperature control device with a setting force, the heat transfer surface being at least partially deformed by the setting force and bearing at least partially flat against the temperature control device.

Furthermore, a method for manufacturing a traction battery according to the approach presented herein is proposed, wherein a heat transfer surface of a battery module according to the approach presented herein is pressed against the tempering device with a setting force, wherein the heat transfer surface is deformed at least proportionally by the setting force and is applied at least proportionally in a planar manner to the tempering device.

A traction battery can be understood as an energy storage device for an electrically driven vehicle. The traction battery can have a housing that encloses components of the traction battery and protects them from mechanical influences and environmental influences. The housing may have internal stiffening elements. The traction battery may have a modular design. The traction battery can be attached to a floor assembly of the vehicle, for example.

A temperature control unit can be part of the housing. In particular, the temperature control unit can be integrated into a base of the traction battery. The temperature control device may be referred to as a cooling plate. The temperature control device may be a heat exchanger for supplying and removing thermal energy. The temperature control device may include a fluid for heat transport. In particular, the temperature control device may include a heat transport fluid. The temperature control device can be supplied by an air conditioning system of the vehicle.

The traction battery can have several battery modules. The battery modules can be arranged between the stiffening elements of the traction battery. A battery module can combine several cells or battery cells. The cells may be electrically interconnected within the battery module. The battery module can also have a housing that encloses the cells. The battery modules can be electrically interconnected within the traction battery.

The battery module can have at least one heat transfer surface thermally coupled to the cells. The heat transfer surface may in particular be a bottom surface of the battery module. The heat transfer surface may comprise end regions of heat conducting sheets arranged between the cells. The heat transfer surface can also be arranged on a side surface of the battery module if the cells and the temperature control device are aligned accordingly.

The heat transfer surface can be thermally coupled to the temperature control unit during production of the traction battery using paste-like heat transfer material. The thermally conductive material can be processed in the pasty or paste-like state and can crosslink or cure after processing. The pasty thermal conductive material may be referred to as a gap filler. The pasty thermal conductive material can have a low thermal resistance. The thermal conductive material may be electrically insulating. The thermal conductive material may have a ceramic filler. The pasty heat-conducting material may have viscous properties under the effect of pressure, i.e. it may be flowable.

During the manufacture of the traction battery, the heat transfer surface is placed on the tempering device. The end portions may be bent or oriented at less than 90°, for example at an angle of between 50° and 89°, preferably between 60° and 85°, with respect to the main extension plane. The end portion of a heat transfer sheet may thus be oriented at an acute angle with respect to a reference plane of the heat transfer surface, the reference plane being perpendicular to the main extension plane of the heat transfer sheet. In this case, the reference plane can be parallel to an end face of two adjacent cells, with the end region of the heat-conducting plate projecting beyond this end face. The heat-conducting sheet can thus have a kink at a transition between the central region and the end region. The end regions may be flat. The end regions may face away from the cells, i.e. a free end of an end region may be further away from the associated cell than a portion of the end region adjacent to the central region. The end region may also be oriented approximately parallel to the reference plane.

Free ends of the end sections can thus first touch down on the temperature control unit during battery assembly. The battery module is then pressed against the temperature control unit with a setting force. During pressing, the end sections bend from the free ends at least partially by a spring deflection or deformation path provided by the design and adapt at least partially to a contour of the temperature control unit. The spring travel or deformation travel does not have to be exhausted during the deformation. As a result of the deformation, the end regions can at least partially achieve a parallel position to a surface of the temperature control unit.

Heat-conducting material located between the heat transfer surface and the temperature control device can be displaced laterally during pressing. Due to the acute angle of the end areas, the heat-conducting material can be displaced in a predetermined direction; a parallel arrangement of the surfaces is also possible Excess heat-conducting material swells out laterally from a gap between the heat transfer surface and the temperature control unit. In the process, the heat-conducting material can compensate for manufacturing tolerances of the end areas and the surface of the temperature control device as it flows. Furthermore, the thermally conductive material can fill a void or gap of the end regions and the surface of the temperature control device. This can result in full-surface contact between the thermally conductive material and the heat transfer surface or the thermally conductive material and the temperature control device. Via the heat-conducting material and the elastic end regions, a full-surface heat-conducting contact can result between the heat transfer surface and the temperature control device.

The end region can be slotted and form at least two deformable partial surfaces of the heat transfer surface. The end regions can be divided into many partial surfaces. Through intervening slits, each partial surface can deform and contact the temperature control device individually. The partial surface can deform elastically and/or plastically according to a proportional pressing force. The partial surfaces can adapt to the contour of the temperature control unit.

Adjacent partial surfaces of the end area can be bent in opposite directions. In particular, the same number of partial surfaces can be bent in both directions. By bending in the opposite directions, the torques introduced into the heat conducting plate by the deformation of the partial surfaces can substantially cancel each other out. The oppositely oriented partial surfaces can conduct the heat evenly distributed to the temperature control device.

One heat conducting plate can be arranged in each of at least two intermediate spaces. Partial surfaces of adjacent heat-conducting sheets facing one another can be arranged laterally offset from one another. The offset arrangement can achieve a regular matrix of partial surfaces of the heat transfer surface. The setting force can thus be introduced uniformly into the tempering device. If heat transfer plates are arranged in all intermediate spaces, the partial surfaces of adjacent end regions can be arranged alternately in a row next to each other. If a heat-conducting plate is arranged every two intermediate spaces, the partial surfaces can be arranged in a checkerboard pattern.

Adjacent partial surfaces of the end area can alternatively be bent in the same direction. The uniform bending direction means that the end region can be bent easily and inexpensively.

Two cells can be arranged between every two heat conducting sheets of a heat transfer surface. In other words, a heat conducting plate can be arranged every two spaces. Thus, each cell has direct contact with a heat-conducting plate on at least one flat side. If the battery module has heat transfer surfaces on two sides, the heat conducting sheets of the different heat transfer surfaces can each be arranged alternately between the cells.

The end regions of the two heat conducting sheets may be bent in opposite directions. The end regions can form ribs. Cavities can be arranged between the ribs to accommodate excess heat-conducting material.

The heat transfer surface can be exclusively elastic. The heat transfer surface can be permanently elastic. That is, the end regions of the heat transfer sheets forming the heat transfer surface may be elastically deformable such that they can be deformed without plastic deformation to a configuration in which an end region abuts an end face of one of the cells. Accordingly, the end regions can cushion any movements of a battery module relative to, for example, the temperature control device of the traction battery. Thus, the end regions may serve as a suspension of the battery module and dampen a transmission of shocks.

### BRIEF DESCRIPTION OF THE SEVERAL VIEWS OF THE DRAWING

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts a sectional view of a traction battery according to an embodiment;

FIG. 2 depicts a detail of a battery module according to an embodiment; and

FIG. 3 depicts an illustration of a battery module according to an embodiment.

The figures are merely schematic representations and serve only to explain the invention. Identical or similarly acting elements are marked throughout with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

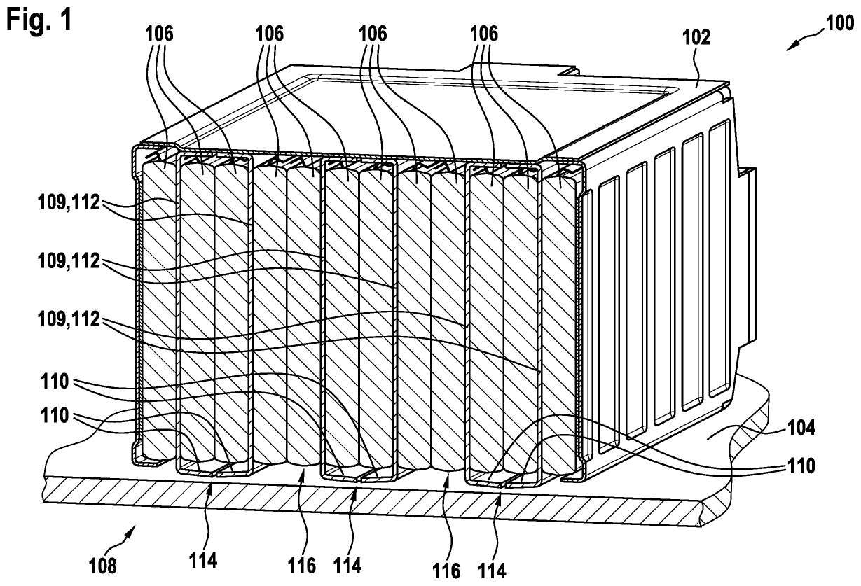

FIG. 1 shows a sectional view of a traction battery 100 according to an embodiment. The traction battery 100 may include a plurality of battery modules 102. Here, one of the battery modules 102 is shown in a cutaway view. The battery modules 102 may be connected in parallel and/or in series in the traction battery 100. For this purpose, the individual battery modules 102 are inserted into a housing or frame of the traction battery 100 and electrically connected to each other. For temperature control of the battery modules 102, the traction battery 100 has a temperature control device 104, which may, for example, be arranged in a base of the housing or may form the base of the traction battery 100. In particular, the temperature control device 104 may be used to cool the battery modules 102. At low temperatures, the temperature control device 104 may also be used to heat the battery modules 102.

The battery module 102 includes a plurality of pouch cells or prismatic cells 106. The cells 106 are arranged flat side to flat side, side by side, within a housing of the battery module 102. The flat sides of the cells 106 are oriented perpendicular to a heat transfer surface 108 of the battery module 102. Here, the heat transfer surface 108 is disposed at a bottom of the housing. The battery module 102 is thermally coupled to the temperature control device 104 via the heat transfer surface 108. The battery module 102 may be coupled to the temperature control device 104 using a heat transfer material not shown here.

Alternatively, the cells 106 may be stacked horizontally on top of each other. In that case, the battery module 102 may include at least one side heat transfer surface 108. Depending on the design of the temperature control device 104, the battery module 102 may also have multiple heat transfer surfaces 108 disposed on different sides of the battery module 102.

In the approach presented herein, the heat transfer surface 108 is formed by folded end regions 110 of heat conduction plates 112 of the battery module 102. Central regions 109 of the heat conduction plates 112 thereby extend in a space between adjacent cells 106 and extend along a main extension plane of the respective heat conduction plate 112. The end regions 110 are thereby not bent perpendicularly to the central regions 109 of the heat conduction plates 112, but extend at an angle different from 90°, i.e., at an oblique angle. The end regions 110 are thus oriented at an acute angle with respect to a reference plane of the heat transfer surface 108 extending perpendicularly to the main extension plane of the heat transfer sheets 112. The end regions 110 thereby extend beyond side portions of the battery module 102. In other words, the side portions stand back from the reference plane.

Due to the acute angle, the end regions 110 hit the temperature control device 104 with one edge first when the battery module 102 is placed. Due to a weight of the battery module 102 and/or a setting force, the end regions 110 are deformed and adapt to the temperature control device 104. The end regions 110 thereby compensate for tolerances in shape and position of the temperature control device 104 and the battery module 102. In essence, the end regions 110 are flex springs and deform at least slightly elastically in each case. The end regions 110 may also deform plastically proportionately if a bending moment resulting from the weight and/or settling force is greater than a bending resistance moment of the end regions 110. It is also possible for the end regions to be arranged in parallel.

The deformation of the end portions 110 increases a contact area between the heat transfer surface 108 and the temperature control device 104.

In one embodiment, two cells 106 are disposed between each of two heat baffles 112. Thus, a heat conducting plate 112 is arranged between every second cell 106. The end regions 110 of adjacent heat conducting sheets 112 are thereby bent in opposite directions. Thus, the edges of each of two end regions 110 are directed toward each other and these end regions 110 form a ridge 114 of the heat transfer surface 108. The folded end regions 110 are shorter than a thickness of the cells to prevent contact between the edges. The edges are thereby disposed on either side of a center of the rib 114. The rib 114 has a gap between the edges at the center. A cavity 116 is thereby arranged between each two ribs 114 for receiving excess heat conducting material.

In an alternative embodiment, heat baffles 112 are disposed between all cells 106 of the battery module 102. This allows the cells to be tempered from both flat sides. The end regions 110 are beveled in the same direction in each case to avoid collisions.

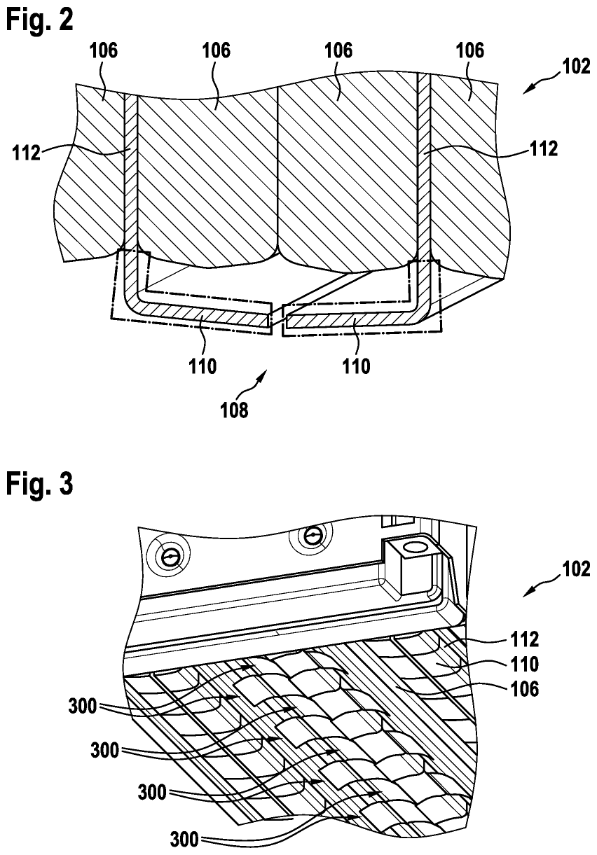

FIG. 2 shows a detail of a battery module 102 according to an embodiment. The battery module is substantially the same as the battery module shown in FIG. 1, where two bent end portions 110 of two heat baffles 112 are shown protruding from the spaces between the cells 106. The portions of the heat conducting sheets 112 projecting from the interstices form an elastic and/or deformable region that can be deformed when the battery module 102 is placed on the temperature control device. In this regard, the end portions 110 oriented obliquely to the reference plane define a spring path or deformation path for the deformation.

FIG. 3 shows an illustration of a battery module 102 according to an embodiment. The battery module is substantially the same as the battery module in FIGS. 1 and 2. Here, the heat transfer surface 108 of the battery module 102 is shown. Here, the end regions 110 are slotted. The slots divide the end regions 110 into individually deformable sub-surfaces 300. The sub-surfaces can deform during placement according to the portion of the placement force acting on them. This allows the heat transfer surface 108 to adapt well to a contour of the temperature control device.

In one embodiment, the partial surfaces 300 of a heat conducting sheet 112 are each beveled in the same direction. Thus, the heat conducting sheet 112 can be easily manufactured. The heat conducting sheets 112 with their end portions 110 form ribs 114 as in FIG. 1.

In an alternative embodiment, the partial surfaces are bent alternately in opposite directions while maintaining the acute angle to the reference plane. In this case, the partial surfaces 300 are each beveled by less than 90 degrees. Free ends of the partial surfaces are thus directed away from the cells 106, respectively. Due to the alternating orientation of the partial surfaces 300, bending moments introduced during placement on the tempering device cancel each other out. Thus, a compressive load on the cells 106 adjacent to the heat conducting plate 112 can be reduced.

In one embodiment, the partial surfaces 300 of adjacent heat transfer plates 112 are laterally offset from each other. Thus, the heat transfer surface 108 is arranged uniformly across the bottom of the battery module 102. The partial surfaces 300 are arranged in a regular pattern.

In other words, a battery module with a heat spreader with an integrated tolerance compensation is presented.

To manufacture a traction battery, cell modules are inserted into a frame or battery housing and thermally bonded to a cooling element (e.g. cooling plate) in the process. Geometric tolerances and flatness of both components can prevent a uniform contact surface and thus a uniform thermal connection.

The approach presented here therefore uses heat-conducting sheets that have an elastic or deformable area to the cooling element. The elastic or deformable area is deformed when the cell modules are placed and thus creates a uniform thermal contact surface.

In addition, pasty or deformable TIM (Thermal Interphase Material) materials such as gap fillers or gappads can be used. With the approach presented here, the use of gap fillers can be avoided or greatly reduced, resulting in cost savings.

The elastic or deformable areas thus enable the elimination of additional materials, simplification of the production process and an increase in the thermal performance of cell modules.

The individual heat conducting plate in a cell module has an elastic or deformable area on at least one side. The cell module consists, for example, of pouch cells that are in thermal contact with the heat conducting sheet. In assembly, the cell module is in thermal contact with a cooling structure. The elastic or deformable region is deformed when the module is assembled to the cooling structure. The elastic area can be structured to create bending fingers that have a defined bending zone, thus ensuring a defined contact area with the cooling element. The cell module can be used in particular in a battery for a vehicle.

Since the devices and methods described in detail above are examples of embodiments, they can be modified in the usual manner by the skilled person to a wide extent without leaving the scope of the invention. In particular, the mechanical arrangements and the proportions of the individual elements with respect to each other are merely exemplary.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary. Some preferred embodiments of apparatus according to the invention have been disclosed above. The invention is not limited to the solutions explained above, but the innovative solutions can be applied in different ways within the limits set by the claims.

What is claimed is:

1. A battery module for a traction battery of an electric vehicle, the battery module comprising:
at least one heat baffle arranged between two cells of the battery module,
wherein a central region of the heat conducting plate extends in a space between the cells along a main extension plane of the heat conducting plate,
wherein an end region of the heat conducting plate is arranged outside the space and is oriented transversely to the main extension plane and is configured to form a deformable heat transfer surface of the battery module, and
wherein the end portion is arranged at an acute angle to a reference plane of the heat transfer surface perpendicular to the main extension plane.

2. The battery module according to claim 1, wherein the end portion is slotted and is configured to form at least two deformable sub-surfaces of the heat transfer surface.

3. The battery module according to claim 2, wherein adjacent partial surfaces of the end portion are bent in opposite directions.

4. The battery module according to claim 3, further comprising a heat conducting plate arranged in each of at least two intermediate spaces, wherein mutually facing partial surfaces of adjacent heat conducting plates are arranged laterally offset with respect to one another.

5. The battery module according to claim 2, wherein adjacent partial surfaces of the end portion are bent in a same direction.

6. The battery module according to claim 1, wherein two cells are arranged between each of two heat conducting plates.

7. The battery module according to claim 5, wherein the end portions of the two heat conducting sheets are bent in opposite directions.

8. A battery module (102) according to any one of the preceding claims, wherein the end portion (110) forming the heat transfer surface (108) is elastically deformable to a configuration in which the end portion (110) abuts an end surface of one of the cells (106).

9. A traction battery for an electric vehicle, comprising:
a temperature control device,
at least one battery module comprising at least one heat baffle arranged between two cells of the battery module, wherein a central region of the heat conducting plate extends in a space between the cells along a main extension plane of the heat conducting plate, wherein an end region of the heat conducting plate is arranged outside the space and is oriented transversely to the main extension plane and is configured to form a deformable heat transfer surface of the battery module, and wherein the end portion is arranged at an acute angle to a reference plane of the heat transfer surface perpendicular to the main extension plane, and
wherein the heat transfer surface is arranged pressed against the temperature control device with a setting force, such that the heat transfer surface is at least partially deformed by the setting force and at least partially bearing flat against the temperature control device.

10. A method of manufacturing a traction battery, the method comprising the steps of:
providing a temperature control device,
providing at least one battery module comprising at least one heat baffle arranged between two cells of the battery module, wherein a central region of the heat conducting plate extends in a space between the cells along a main extension plane of the heat conducting plate, wherein an end region of the heat conducting plate is arranged outside the space and is oriented transversely to the main extension plane and is configured to form a deformable heat transfer surface of the battery module, and wherein the end portion is arranged at an acute angle to a reference plane of the heat transfer surface perpendicular to the main extension plane, and
wherein the heat transfer surface is arranged pressed against the temperature control device with a setting force, such that the heat transfer surface is at least partially deformed by the setting force and at least partially bearing flat against the temperature control device, and
wherein a heat transfer surface of a battery module comprising at least one heat baffle arranged between two cells of the battery module, wherein a central region of the heat conducting plate extends in a space between the cells along a main extension plane of the heat conducting plate, wherein an end region of the heat conducting plate is arranged outside the space and is oriented transversely to the main extension plane and is configured to form a deformable heat transfer surface of the battery module, and wherein the end portion is arranged at an acute angle to a reference plane of the heat transfer surface perpendicular to the main extension plane, such that the battery module is pressed against the temperature control device with a setting force, and
wherein the heat transfer surface is at least partially deformed by the setting force and is at least partially applied a really to the temperature control device.
